(19) United States
(12) Patent Application Publication
(10) Pub. No.: US 2007/0123214 A1
(43) Pub. Date: May 31, 2007

(54) Mobile device system and strategies for determining malicious code activity

(75) Inventor: Von A. Mock, Boynton Beach, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/286,545

(22) Filed: Nov. 25, 2005

(51) Int. Cl. H04M 3/16

(52) U.S. Cl. 455/410

(57) ABSTRACT

A system (300) and mobile wireless radio security method (500) can include a transceiver (320) and a processor (302) coupled to the transceiver. The processor can be programmed to monitor (502) for abnormalities or rare activities from a mobile wireless device when attempting a transmission and to suppress (516) the transmission when an abnormality or rare activity is detected at the mobile wireless device (12). The processor can further be programmed to monitor (504) a rate of speed of the mobile wireless device and suppress transmissions when the speed of the mobile wireless device exceeds a predetermined speed. The processor can be programmed to monitor (506) emails or messages to address book or phone book entries that are rarely contacted individually or as a group and programmed to suppress transmissions of such emails or messages until a user manually confirms the transmissions

### FIELD OF THE INVENTION

This invention relates generally to methods and systems to protect wireless communication systems from security breaches and malicious attacks, and more particularly to systems and methods at a mobile radio that will mitigate or eliminate such security breaches or attacks.

### BACKGROUND OF THE INVENTION

The evolution of mobile technology from a simple telephone with capabilities such as an organizer to a more intelligent and sophisticated miniature computing device including gaming, video streaming, or web-based applications has been one of the goals of mobile device manufacturers. In recent years, vendors in the cellular market aimed at providing more user desirable features in an attempt to increase their subscription rate. As these additional implemented features and functions become more user oriented and controlled, the associated vulnerabilities in this technology also increases.

Although most of the attention in wireless security is geared toward authentication and encryption technologies that typically causes a complete denial of use, relatively little attention is geared towards mobile security where a user on a mobile radio has already been authenticated. Security experts have been giving ample warnings for required improvements in this area. There is no technology that is hacker-proof and the recent scares such as the “Cabir” virus/worm that infected the Symbian operating system that runs on a number of mobile radios, including the Nokia brand is actual proof of the forthcoming challenges. Diana Muriel of CNN in her article entitled “Threat of mobile virus attack real” on Oct. 15, 2003 stated that “Windows operating system has been on the receiving end of more than 60,000 viruses” and believes this trend is going to be followed by many imitators as well as new types of security concerns. Therefore intrusion-detection and resolution measures before the problems get out of control are being implemented. Once a mobile gets infected, it could launch a malicious chain reaction of attacks (mutation attacks) directed towards other mobile stations in a network as well as the network itself.

Currently, there are authentication and encryption technologies that are being proposed by the IS2000C/D and other wireless standards. The proposals are for the complete denial of unauthorized users and users' data integrity, however, there is no specific implementation or technology to prevent or suspend only the specific services of an infected portable-mobile device, or malicious mobile devices that have already been authenticated from accessing the wireless network and potentially compromising the entire network by causing one or more among a system outage, reduced services to other users, system flooding with malicious traffic, or a chain reaction or infections. Nor are there technologies that take uniquely examiner the mobile device domain for abnormal activity specific to the mobile device. For example, one existing application determines if malicious code is running on a mobile device by examining the execution thread in the software, but fails to look at elements normally associated with a mobile device. Similarly, Microsoft outlook uses a strategy that identifies the rate at which emails are sent out to gauge whether malicious activity is present. Again, normal activity relevant to a mobile device is not monitored.

### SUMMARY OF THE INVENTION

Embodiments in accordance with the present invention can provide prevention, detection, and action/recovery from an attack on a mobile by reducing or constraining the impact a virus can have itself, other mobile phones and even the infrastructure. Embodiments herein aid in the detection of any intrusions as well as situations where the virus has already infiltrated the mobile. In particular, embodiments herein can attempt to detect unauthorized activity on a mobile device such as a phone by determining the state or context of the phone. If the phone is a clam-shell style device and is closed, it is not likely to be sending messages. If the phone is traveling at a high rate of speed, it unlikely to be sending messages. If multiple copies of the same message are being sent to the same user is another possible indicator of malicious activity. If these or other similar conditions exist then the user maybe asked to confirm sending of messages.

In a first embodiment of the present invention, a mobile radio security method can include the steps of monitoring for abnormalities or rare activities from a mobile wireless device when attempting a transmission and suppressing the transmission when an abnormality or rare activity is detected at the mobile wireless device. Monitoring can involve monitoring a rate of speed of the mobile wireless device and suppressing transmissions when the speed of the mobile wireless device exceeds a predetermined speed or monitoring emails or messages to address book or phone book entries that are rarely contacted individually or as a group and suppressing transmissions of such emails or messages until a user manually confirms the transmissions. Monitoring can involve monitoring if the mobile wireless device has a flip portion that is in a closed position while attempting a transmission or a reception, and suppressing the transmission or reception when the flip portion is in the closed position or monitoring if the mobile wireless device is holstered or worn on a user's body while attempting a transmission or a reception, and suppressing the transmission or reception when the mobile wireless device is holstered or worn on the user's body. Monitoring can also involve monitoring of transmissions if the mobile wireless device is unholstered or off a user's body and motionless and suppressing at least portions of such transmission that contain non-preconfigured data types. The method can further include monitoring behavior of a user and suppressing transmissions or receptions to the mobile wireless device when the behavior of the user fails to meet a predetermined profile stored within the mobile wireless device. The method can also include the step of suspending packet data services at a mobile radio upon detection of a malicious software routine in the mobile radio while continuing to enable voice or circuit data calls.

In a second embodiment of the present invention, a mobile wireless radio security system can include a transceiver and a processor coupled to the transceiver. The processor can be programmed to monitor for abnormalities or rare activities from a mobile wireless device when attempting a transmission and to suppress the transmission when an abnormality or rare activity is detected at the mobile wireless device. The processor can further be programmed to monitor a rate of speed of the mobile wireless device and suppress transmissions when the speed of the mobile wireless device exceeds a predetermined speed. The processor can be programmed to monitor emails or messages to address book or phone book entries that are rarely contacted individually or as a group and programmed to suppress transmissions of such emails or messages until a user manually confirms the transmissions. The processor can be further programmed to monitor if the mobile wireless device has a flip portion that is in a closed position while attempting a transmission or a reception, and further programmed to suppress the transmission or reception when the flip portion is in the closed position. The processor can also be programmed to monitor if the mobile wireless device is holstered or worn on a user's body while attempting a transmission or a reception, and further programmed to suppress the transmission or reception when the mobile wireless device is holstered or worn on the user's body. In another alternative, the processor can be programmed to monitor transmissions if the mobile wireless device is in a condition of being unholstered or off a user's body and motionless and further programmed to suppress at least portions of such transmission that contain non-preconfigured data types when under the condition. The processor can also monitor behavior of a user and to suppress transmissions or receptions to the mobile wireless device when the behavior of the user fails to meet a predetermined profile stored within the mobile wireless device. The processor can be further programmed to suspend packet data services at a wireless device upon detection of a malicious software routine in the mobile wireless device while continuing to enable voice or circuit data calls.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a wireless mobile radio that include a security system for suppressing malicious code attacks in accordance with an embodiment of the present invention.

FIG. 2 is a block diagram of wireless mobile radio security system in accordance with an embodiment of the present invention.

FIG. 3 is a flow chart illustrating a security method in a mobile wireless radio in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

There are a broad list of attacks such as physical access attacks including wiretapping, server hacking, and vandalism, and dialog attacks such as eavesdropping, impersonation, message alteration, and penetration attacks such as scanning (probing), break-in, Denial of Service (DoS), Malware, Viruses, and Worms, and social engineering such as opening attachments, password theft, and information theft to be concerned about with any computing device. As discussed above, viruses are spreading in the mobile domain with greater prevalence as mobile handsets include additional features and provide more open operating system functionality. Recent news of Nokia's Symbian based phones have gained media attention as individuals are able to send malicious instructions via the Bluetooth link to the device. Quite a few solutions have been proposed dealing with trusted devices, particularly for peer-to-peer network computing or dealing with a trusted central model. A number of strategies are also currently in place to help reduce the impact of malicious code such as backing up data in case of corruption, authenticating a user sending data, examining data going through a network for malicious activity and other forms that watch the activity on a stationary device. As of yet, no security system determines malicious activity in a mobile device by leveraging the mobile device attributes. Thus, embodiments herein monitor the mobile device domain to bring in additional capabilities to determine malicious activity.

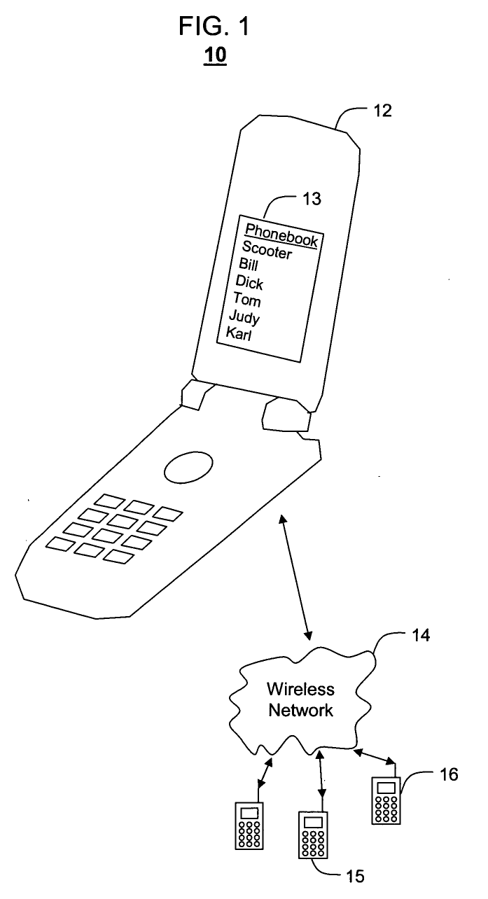

A list of aspects of the mobile device domain that can be leveraged for strategies to reduce the impact of malicious device activity can include monitoring or security programs or software that can determine if a sending device is moving at a high rate of speed as determined by an location determining device such as an satellite position system receiver (SPS) or GPS device. The strategy involved here accounts for user behavior that is unlikely. In other words, a user of a wireless device 12 as illustrated in FIG. 1 is unlikely to send messages while traveling at a high rate of speed or walking briskly. A combination of other strategies can further increase the probability of determining malicious code.

In another aspect involving the mobile device domain, the mobile device 12 can include a user interface 13 such as a screen enabling the viewing of a phonebook or address book having a plurality of entries. The entries can be contact numbers for any number of devices such as cellular phones 15 and 16 or wireless messaging device (not shown) that can communicate with the device 12 over a wireless network 14 or can include contact numbers for wired phones (not shown) through a combination of wireless and/or wired networks. Thus, monitoring communication to several address book entries that have not been contacted for a long period of time can be considered abnormal or suspicious activity in the context of the mobile device domain. Instances where several different groups or members of different groups (such as family members, work members, and friends) are copied multiple times with the same email would likely be considered abnormal, suspicious, or malicious since email or other messages are most likely not applicable to multiple groups.

In another use case, a mobile device 12 having a clam shell or flip in the closed position that is transmitting or receiving a message might be considered an abnormal event. The mobile device does not need to execute on a receiving message while the clam is closed or while worn on body. In yet another use case, where the mobile device is off the body and no movement is detected (such as through an accelerometer or de-sensing of the antenna), an abnormal status can be determined if the mobile device is trying to transmit or wanting to execute a data portion received. In the case of transmitting, the mobile device can be programmed to prevent transmission of certain data types not already configured. For example, a vcard or vcalendar can be allowed to be transmitted while a message to another recipient with an unknown information type would be suppressed. In each of these instances or cases, the user can be prompted to verify the activity is appropriate as the security program “learns” the “normal” behavior of the user and the mobile device.

One of the “abnormalities” that can be detected besides an infected application on a mobile radio can include a location reported by the mobile radio that is inconsistent with a location reported by a base station or radio access network in communication with such mobile radio 12. If an abnormality is found, air interface messaging can be used to deny resources in a selective manner to the offending mobile radio (selective suspension of HTTP, FTP, mail (SMTP+POP 3), ICMP or others). Other alternatives can include refusing resource assignments or allocation for the offending application or redirecting service to an analog service or to other carriers that do not provide data services for example. The system 10 can also assist in tracking infected users or infection proliferators by making location queries that can provide among other things a base transceiver station location or a mobile radio location based on GPS or triangulation or other nearby communication device ID.

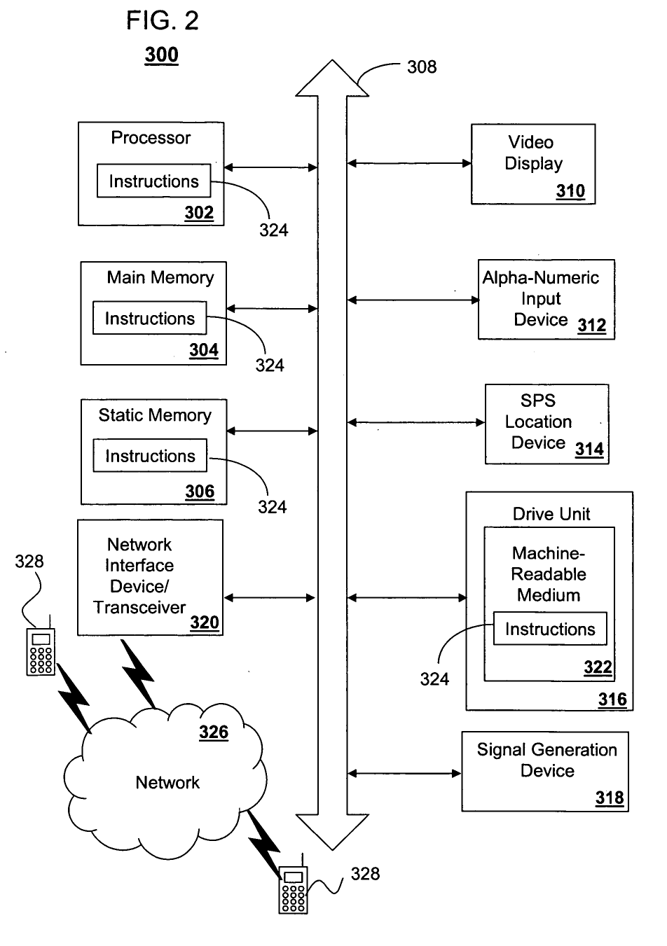

Referring to FIG. 2, an electronic product or wireless device in the form of a computer system 300 can include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard or keypad), a satellite position system device 314 (e.g., a GPS receiver), a disk drive unit 316, a signal generation device 318 (e.g., a speaker or remote control or microphone) and a network interface device 320.

The disk drive unit 316 may include a machine-readable medium 322 on which is stored one or more sets of instructions (e.g., software 324) embodying any one or more of the methodologies or functions described herein, including those methods discussed below. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

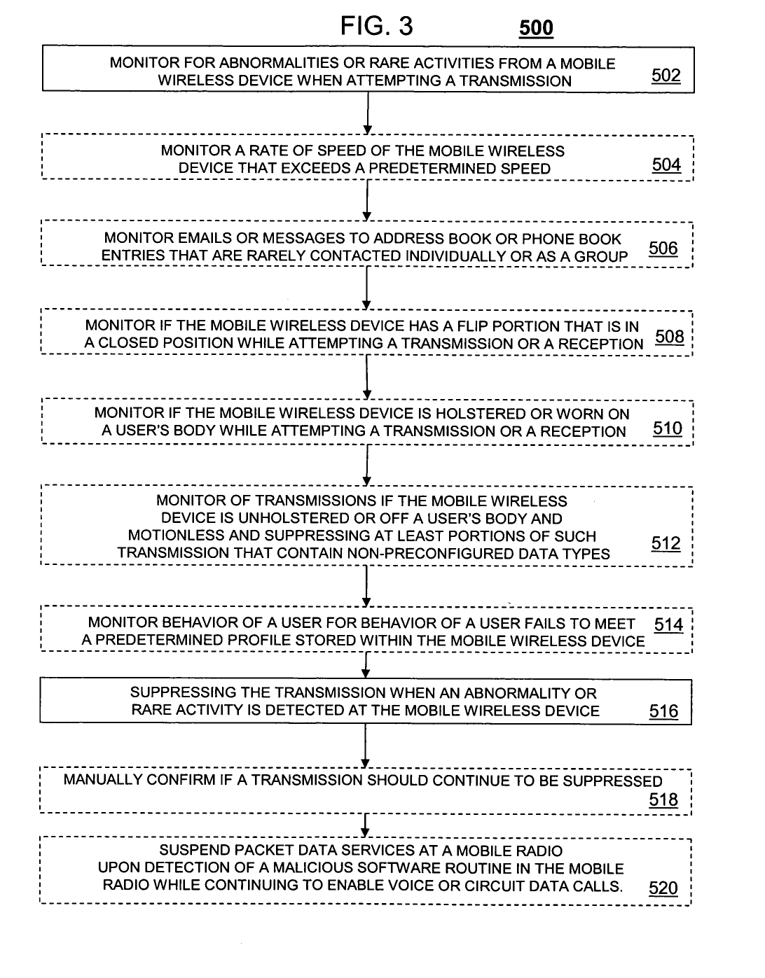

Referring to FIG. 3, a mobile radio security method 500 can include the step 502 of monitoring for abnormalities or rare activities from a mobile wireless device when attempting a transmission and suppressing the transmission at step 516 when an abnormality or rare activity is detected at the mobile wireless device. Monitoring can involve monitoring a rate of speed of the mobile wireless device at step 504 and suppressing transmissions when the speed of the mobile wireless device exceeds a predetermined speed or monitoring emails or messages to address book or phone book entries that are rarely contacted individually or as a group at step 506 and suppressing transmissions of such emails or messages until a user manually confirms the transmissions at step 518. Monitoring can involve monitoring at step 508 if the mobile wireless device has a flip portion that is in a closed position while attempting a transmission or a reception, and suppressing the transmission or reception when the flip portion is in the closed position or monitoring at step 510 if the mobile wireless device is holstered or worn on a user's body while attempting a transmission or a reception, and suppressing the transmission or reception when the mobile wireless device is holstered or worn on the user's body. Monitoring can also involve the step 512 of monitoring of transmissions when the mobile wireless device is unholstered or off a user's body and motionless and suppressing at least portions of such transmission that contain non-preconfigured data types. The method 500 can further include monitoring behavior of a user at step 514 and suppressing (516) transmissions or receptions to the mobile wireless device when the behavior of the user fails to meet a predetermined profile stored within the mobile wireless device. The method 500 can also include the step 520 of suspending packet data services at a mobile radio upon detection of a malicious software routine in the mobile radio while continuing to enable voice or circuit data calls.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A mobile radio security method, comprising the steps of:
monitoring for abnormalities or rare activities from a mobile wireless device when attempting a transmission; and
suppressing the transmission when an abnormality or rare activity is detected at the mobile wireless device.

2. The method of claim 1, wherein the method further comprises the step of monitoring a rate of speed of the mobile wireless device and suppressing transmissions when the speed of the mobile wireless device exceeds a predetermined speed.

3. The method of claim 1, wherein the method further comprises the step of monitoring emails or messages to address book or phone book entries that are rarely contacted and suppressing transmissions of such emails or messages until a user manually confirms the transmissions.

4. The method of claim 1, wherein the method further comprises the step of monitoring emails or messages to address book or phone book entries that are rarely contacted as a group and suppressing transmissions of such emails or messages until a user manually confirms the transmissions.

5. The method of claim 1, wherein the method further comprises the step of monitoring if the mobile wireless device has a flip portion that is in a closed position while attempting a transmission or a reception, and suppressing the transmission or reception when the flip portion is in the closed position.

6. The method of claim 1, wherein the method further comprises the step of monitoring if the mobile wireless device is holstered or worn on a user's body while attempting a transmission or a reception, and suppressing the transmission or reception when the mobile wireless device is holstered or worn on the user's body.

7. The method of claim 1, wherein the method further comprises the step of monitoring of transmissions if the mobile wireless device is unholstered or off a user's body and motionless and suppressing at least portions of such transmission that contain non-preconfigured data types.

8. The method of claim 1, wherein the method further comprises the step of monitoring behavior of a user and suppressing transmissions or receptions to the mobile wireless device when the behavior of the user fails to meet a predetermined profile stored within the mobile wireless device.

9. The method of claim 1, wherein the method further comprises the step of suspending packet data services at a mobile radio upon detection of a malicious software routine in the mobile radio while continuing to enable voice or circuit data calls.

10. A mobile wireless radio security system, comprising:
a transceiver; and
a processor coupled to the transceiver, wherein the processor is programmed to:
monitor for abnormalities or rare activities from a mobile wireless device when attempting a transmission; and
suppress the transmission when an abnormality or rare activity is detected at the mobile wireless device.

11. The system of claim 10, wherein the processor is further programmed to monitor a rate of speed of the mobile wireless device and suppressing transmissions when the speed of the mobile wireless device exceeds a predetermined speed.

12. The system of claim 10, wherein the processor is further programmed to monitor emails or messages to address book or phone book entries that are rarely contacted individually or as a group and programmed to suppress transmissions of such emails or messages until a user manually confirms the transmissions.

13. The system of claim 10, wherein the processor is further programmed to monitor if the mobile wireless device has a flip portion that is in a closed position while attempting a transmission or a reception, and further programmed to suppress the transmission or reception when the flip portion is in the closed position.

14. The system of claim 10, wherein the processor is further programmed to monitor if the mobile wireless device is holstered or worn on a user's body while attempting a transmission or a reception, and further programmed to suppress the transmission or reception when the mobile wireless device is holstered or worn on the user's body.

15. The system of claim 10, wherein the processor is further programmed to monitor transmissions if the mobile wireless device is in a condition of being unholstered or off a user's body and motionless and further programmed to suppress at least portions of such transmission that contain non-preconfigured data types when under the condition.

16. The system of claim 10, wherein the processor is further programmed to monitor behavior of a user and to suppress transmissions or receptions to the mobile wireless device when the behavior of the user fails to meet a predetermined profile stored within the mobile wireless device.

17. The system of claim 10, wherein the processor is further programmed to suspend packet data services at a wireless device upon detection of a malicious software routine in the mobile wireless device while continuing to enable voice or circuit data calls.

18. A machine-readable storage, having stored thereon a computer program having a plurality of code sections executable by a machine for causing the machine to perform the steps of:
monitoring for abnormalities or rare activities from a mobile wireless device when attempting a transmission; and
suppressing the transmission when an abnormality or rare activity is detected at the mobile wireless device.

19. The machine readable storage of claim 18, wherein the computer program further comprises a plurality of code section for causing a machine to monitor a rate of speed of the mobile wireless device and suppressing transmissions when the speed of the mobile wireless device exceeds a predetermined speed or monitor emails or messages to address book or phone book entries that are rarely contacted individually or as a group and suppressing transmissions of such emails or messages until a user manually confirms the transmissions.

20. The machine readable storage of claim 18, wherein the computer program further comprises a plurality of code section for causing a machine to monitor if the mobile wireless device has a flip portion that is in a closed position while attempting a transmission or a reception, and suppressing the transmission or reception when the flip portion is in the closed position.
